(19) United States
(12) Patent Application Publication
(10) Pub. No.: US 2026/0286073 A1
(43) Pub. Date: Sep. 24, 2026

(54) Reinforced Thermoplastic Composite With a Charcoal Additive

(71) Applicant: Bernastic, LLC, ATLANTA, GA (US)

(72) Inventor: Michael Bernstein, Atlanta, GA (US)

(21) Appl. No.: 19/291,637

(22) Filed: Aug. 6, 2025

Related U.S. Application Data
(63) Continuation of application No. 19/086,676, filed on Mar. 21, 2025.

(51) Int. Cl. C08J 5/04; B29B 9/06; B29B 13/06; B29K 23/00; B29K 311/10; B33Y 70/10; C08L 23/06; C09D 7/40; C09D 7/65; C09D 123/06

(52) U.S. Cl. CPC C08J 5/045; B29B 9/065; B29B 13/065; B33Y 70/10; C08J 5/046; C08L 23/06; C09D 7/65; C09D 7/70; C09D 123/06; B29K 2023/065; B29K 2311/10; C08J 2323/06; C08L 2203/30; C08L 2205/16; C08L 2207/062; C08L 2207/20

(57) ABSTRACT

The present invention relates to a reinforced composite and a method for producing the same. The method comprises the steps of collecting airborne yarn waste and/or cotton waste dust, forming the waste/dust into a plug form, and feeding the plug into a compounding system. A thermoplastic polymer, a bonding agent, and a charcoal additive are introduced into the compounding system and compounded under heat and shear to produce the reinforced composite material. This composition and method not only enable the efficient recycling of textile waste but also results in a composite with enhanced tensile strength, improved odor control, and superior durability compared to conventional thermoplastic composites.

### FIELD OF THE INVENTION

The present invention relates to the use of airborne yarn waste and cotton waste dust to reinforce thermoplastic composites, and more particularly, a reinforced thermoplastic composite with a charcoal additive to both mitigate foul odors and enhance the tensile strength of the resulting composite or end product.

### BACKGROUND

### Interpretation Considerations

This section describes the technical field in detail and discusses problems encountered in the technical field. Therefore, statements in the section are not to be construed as prior art.

### Discussion

The rise of fast fashion has significantly increased the production and disposal of clothing, leading to a surge in textile waste and global pollution. Globally, the fashion industry is responsible for approximately 10% of carbon emissions, 20% of industrial water pollution, and extensive land and resources used for fiber production. Despite advancements in recycling technologies, less than 1% of clothing is recycled into new textiles, with most apparel waste ending up in landfills or being incinerated, exacerbating environmental harm. Though textile recycling methods have evolved, the effective reuse and recycling of both pre-consumer (manufacturing scraps) and post-consumer (discarded clothing) apparel waste still remain unresolved. Cotton-based materials, which are widely used in the production of textiles, generate substantial amounts of apparel waste during various processing stages. This waste is often discarded or underutilized, leading to resource inefficiencies and environmental harm.

Recycling waste apparel from textile fabrication presents significant challenges due to the low-density and amorphous nature of cotton waste or airborne yarn waste. These characteristics make transportation inefficient, as the material is bulky, lightweight, and prone to entanglement, requiring extensive handling and large storage volumes. The same issues also create challenges when feeding into compounding processes for reinforced composites. Its irregular structure prevents smooth and consistent feeding, leading to poor dispersion within the composite matrix. Unlike granular or pelletized reinforcements, cotton waste resists uniform mixing, resulting in material inconsistencies that compromise the biomechanical properties of the final composite. These processing difficulties limit the scalability and practicality of using cotton waste in advanced material applications.

The patent WO2021250228A1 focuses on utilizing recycled post-consumer waste to produce reinforced composite materials, specifically emphasizing the collection and processing of fibrous waste from discarded textiles and plastics rather than pre-consumer yarn waste or other pre-consumer waste. The process involves harvesting post-consumer waste through municipal or industrial collection, sorting to remove contaminants, and converting it into a usable form for compounding with resins or binders. However, post-consumer waste presents several manufacturing and operational inefficiencies. Feeding post-consumer cotton into compounding machines also poses challenges due to its physical form, as loose, lightweight fibers do not disperse uniformly within the polymer matrix, leading to inconsistent fiber distribution and reduced composite performance. Additionally, post-consumer fibers often retain dyes, chemical treatments, and contaminants from prior use, which can negatively affect the final composite properties. Removing or neutralizing these chemicals requires additional processing steps such as washing, bleaching, or chemical treatments, increasing complexity and cost.

Beyond the transportation challenges, achieving uniform dispersion of reinforcement materials within a polymer matrix is critical to ensuring optimal mechanical properties. However, when cotton or other recycled textiles are used, they exhibit poor dispersion rates when blended with thermoplastic polymers such as high-density polyethylene (HDPE). The fibrous structure results in uneven distribution within the molten polymer, leading to inconsistencies in the final composite material. This poor integration can result in weak points, reducing the overall strength and durability of the composite.

Existing solutions for recycling cotton fiber focus on low-value applications, such as insulation or padding materials. These methods fail to leverage the potential of pre-consumer apparel waste for creating durable materials with enhanced properties, such as improved tensile strength or rigidity. Furthermore, there is a lack of cost-effective and scalable technologies capable of transforming this underutilized resource into valuable products.

The integration of natural fibers such as cotton lint or cotton waste into thermoplastic polymers has garnered significant interest in recent years, driven by the need for sustainable, biodegradable, and cost-effective composite materials. These bio-composites are increasingly used in a variety of applications, including automotive components, packaging, construction materials, and consumer goods, due to their favorable mechanical properties, renewability, and reduced environmental footprint. However, a major technical challenge encountered during the manufacturing of such composites, particularly when utilizing extrusion processes, is the generation of undesirable and persistent foul odors in the end product or final composite or compositions. There is currently a void in the art for mitigating the foul odors emanating from the extrusion process in the manufacturing of certain reinforced thermoplastics.

The root cause of these malodors lies in the inherent chemical composition of cotton fibers and the thermal conditions required for thermoplastic processing. The cotton waste contains not only cellulose but also residual lignin, waxes, fatty acids, proteins, and other organic impurities that are prone to thermal degradation at the temperatures typically used in extrusion (ranging from 150° C. to 250° C.). This degradation leads to the release of volatile organic compounds (VOCs), including aldehydes, ketones, organic acids, and sulfur or nitrogen-containing compounds, all of which contribute to the unpleasant odor profile of the finished composite. Additionally, incomplete polymerization or breakdown of certain thermoplastic additives, such as plasticizers and stabilizers, may worsen the issue by generating further odorous byproducts. Traditional mitigation strategies, such as enhanced ventilation, the use of masking fragrances, or post-processing deodorization, have proven inadequate, as they do not fundamentally prevent the formation of odor-causing compounds or may negatively impact on the material's physical properties.

These methods often suffer from poor compatibility with the hydrophilic nature of cellulose, insufficient adsorption capacity for the broad spectrum of VOCs produced, or adverse effects on the mechanical integrity and processability of the composite. For example, zinc-based odor absorbers, effective in synthetic polymers, are less suitable for cotton-polymer blends due to potential reactivity with fiber components and incompatibility with the matrix. The growing demand for high-performance, eco-friendly composites thus highlights an unmet need for a novel material composition and manufacturing method that may effectively suppress or eliminate the formation of malodorous compounds during processing, without compromising the desirable properties of the end product.

Therefore, there is a need for a reinforced thermoplastic composite with a charcoal additive that not only addresses existing inefficiencies but also enables scalable production of high-performance, improved tensile strength, odor-free, and sustainable bio-composites.

### SUMMARY

An objective of the present invention is to provide an apparatus and method for compacting airborne yarn waste and, or cotton waste dust into a cotton waste plug. By incorporating a cotton waste plug into the composite, the material exhibits higher tensile strength, making it suitable for a wide range of applications where durability is crucial.

Another advantage of the present invention is the formation of a compact cotton waste plug by converting the airborne yarn waste and, or cotton waste dust into a plug form. This transformation makes the transportation of cotton waste much more efficient and cost-effective. By minimizing the volume of the waste, it becomes easier to handle and transport from one location to another, thereby reducing logistical costs and environmental impact.

An objective of the present invention is to provide a reinforced thermoplastic composite with a charcoal additive and method for producing the same to provide improved odor control, and superior durability compared to conventional thermoplastic composites.

Yet another objective of the present invention is to enable efficient, scalable manufacturing of durable, eco-friendly components for diverse industrial applications.

Cotton waste dust and airborne yarn waste (dust/waste) are two distinct types of pre-consumer cotton waste materials that serve as inputs for the compaction process to create cotton waste plugs. Cotton waste dust is a fine particulate byproduct generated during the combing process, where short fibers, broken fragments, and impurities are separated from longer staple fibers to enhance yarn quality. This dust, collected through extraction and filtration systems, is reintroduced into the spinning process to create yarn, maximizing fiber utilization. In contrast, airborne yarn waste consists of larger fiber clusters, stray filaments, and lint that become detached and suspended in the air during fabrication processes such as spinning, weaving, and knitting. This waste, which is captured through air filtration systems, represents an additional input for cotton waste plug production. Both cotton waste dust and airborne yarn waste are inputs for the compaction process, where they are compressed into cotton waste plugs for downstream reinforced composite manufacturing. Optionally, the cotton waste plug may be compacted from either input alone. Optionally, the densified cotton waste plug is configured for packaging and shipping, and then subject to manual shredding or automated shredding prior to being fed and compounded with the HDPE, bonding agent, etc., to form the reinforced thermoplastic.

Furthermore, the present invention offers reduced production costs. By leveraging waste materials and optimizing manufacturing processes, the cost of producing these composites is significantly lower than traditional methods, making them more accessible to industries seeking sustainable solutions.

Additionally, the present invention boosts the reusability and value of airborne yarn waste and, or cotton waste dust. By transforming this underutilized resource into durable end products, the invention contributes to resource efficiency and waste reduction, aligning with sustainable development goals.

This and other objectives are achieved by providing a system, an apparatus and a method for manufacturing a cotton waste plug and a blended composition with the features in the independent claims.

According to the first aspect of the present invention, the present invention provides a cotton waste plug from airborne yarn waste and, or cotton waste dust. The cotton waste plug comprises airborne yarn waste and, or cotton waste dust collected by vacuuming through a negative air environment. Further, the waste/dust is compacted into a cotton waste plug shape configured for at least one of ease of transport and storage.

In another embodiment of the present invention, the cotton waste plug is processed into a plug shape by vacuuming waste/dust from the air through a negative air environment and compacting the waste/dust into a cylindrical shape. The waste/dust is compacted into the plug shape using at least one of mechanical pressing, hydraulic compression, extrusion-based densification, thermal bonding, or chemical binding agents.

In one embodiment of the present invention, the formation of the cotton waste plug is not a result of deliberate compaction, post-processing, or secondary shaping steps. Instead, the plug assumes its final form as a natural consequence of the manufacturing process. Specifically, the system utilizes a negative air pressure environment to collect dust/waste, directing it through a controlled airflow system into a compaction chamber where it is consolidated into a cylindrical shape. As the continuous column of compacted waste/dust exits the processing apparatus through tubing or piping, gravitational forces cause the material to segment naturally into discrete, uniformly shaped plugs. The inherent structural integrity of the compacted cotton fibers, combined with the controlled exit conditions, ensures that the plugs break off with consistent dimensions, texture, and mechanical properties, eliminating the need for additional processing steps to achieve the final shape.

In yet another embodiment of the present invention, the cotton waste plug further comprises a humidity level of less than 10%.

According to a second aspect of the invention, the invention provides an apparatus for manufacturing a cotton waste plug. The apparatus comprises an input source unit, a plunger unit and an output unit. The input source unit receives and vacuums the waste/dust from the air through a negative air environment. The plunger unit compacts the received waste/dust. The output unit compacts and outputs the waste/dust into a plug shape.

In an embodiment of the present invention, the plunger unit compacts the waste/dust into the plug shape using at least one of mechanical pressing, hydraulic compression, extrusion-based densification, thermal bonding, or chemical binding agents.

In an embodiment of the present invention, the output unit includes a shaping die structure to output the compacted plug in any desired shape and dimension.

According to a third aspect of the present invention, the invention provides a method of manufacturing a cotton waste plug. The method comprises the steps of a) obtaining airborne yarn waste/cotton waste dust from pre-consumer industrial sources; and b) compacting the dust/waste into a plug shape using at least one of mechanical pressing, hydraulic compression, extrusion-based densification, thermal bonding, or chemical binding agents.

In yet another aspect of the present invention, the plug shape is further combined with a thermoplastic polymer and bonding agent to produce a reinforced composite material.

In yet another aspect of the present invention, the airborne yarn waste and cotton waste dust may be collected and combined with the thermoplastic polymer and bonding agent to produce the reinforced composite material, without the need to form the yarn waste/cotton waste dust into a plug shape or cotton waste plug.

In yet another aspect of the invention, the yarn waste/cotton waste dust in plug form is further shredded, manually or in automated fashion, in order to be fed into the respective feed of the compounding machine.

In one embodiment of the present invention, the reinforced composite material is outputted as pellets from the compounding process, ensuring uniform dispersion of the cotton waste fibers within the thermoplastic polymer matrix. The incorporation of the cotton waste plug-derived fibers into the polymer results in enhanced bio-mechanical properties, including improved tensile strength, impact resistance, and flexural modulus. The natural fiber reinforcement contributes to increased durability and load-bearing capacity, making the composite material suitable for demanding structural applications. Additionally, the inherent characteristics of cotton fibers, such as their low density and ability to enhance thermal and acoustic insulation, further expand the material's potential applications.

Once formed into pellets, the reinforced composite material can be subsequently injection molded into a wide range of end-use consumer and industrial products. Potential applications include durable pallets for logistics and shipping, eco-friendly furniture components, hangers, automotive interior panels, construction materials such as decking boards and wall panels, and consumer goods like storage bins, tool handles, and packaging materials. The ability to efficiently integrate airborne yarn waste and, or cotton waste dust into thermoplastic composites not only improves the sustainability of these end-products but also contributes to circular economic efforts by repurposing textile waste into high-performance materials.

According to a fourth aspect of the present invention, the present invention provides a reinforced composite material. The reinforced composite material comprises airborne yarn waste and/or cotton waste dust (waste/dust) in a plug form, a bonding agent, a thermoplastic polymer, and a charcoal additive. The airborne yarn waste and/or cotton waste dust is compounded with the thermoplastic polymer, bonding agent, and charcoal additive to form a reinforced composite material. The use of waste materials and additives results in a cost-effective, environmentally friendly composite material with enhanced tensile strength.

In an embodiment of the present invention, the charcoal additive comprises at least one of an activated charcoal, biochar, or carbon black derived from biomass or recycled organic material. The use of charcoal additives from sustainable sources further enhances the environmental benefits and imparts improved adsorption, filtration, and mechanical properties to the composite material.

In another embodiment of the present invention, the charcoal additive is provided in a particulate form selected from powder, granules, or micronized particles suitable for uniform mixing during compounding. The particulate form of the charcoal additive ensures homogeneous dispersion within the composite material, thereby enhancing its structural integrity and functional performance.

In another embodiment of the present invention, the charcoal additive is present in an amount ranging from 0.5% to about 2.5% by weight of the total composition. Optimizing the charcoal additive content within this range provides a balance between improved functional properties and cost-effectiveness, without adversely affecting the processability or mechanical strength of the composite material.

In still another embodiment of the present invention, the charcoal additive is introduced during compounding by at least one of pre-mixing with the fiber plug, blending with the thermoplastic polymer or bonding agent, or via a dedicated feeder into the compounding system. The flexible methods of introducing the charcoal additive enable efficient integration and uniform distribution within the composite material, thereby optimizing its performance and manufacturability.

In yet another embodiment of the present invention, the charcoal additive is introduced during the compounding process by at least one of premixing with the fiber plug prior to feeding, co-feeding into the melt zone through a dedicated feeder, or pre-blending with the polymer resin prior to compounding. These versatile introduction methods ensure thorough and consistent incorporation of the charcoal additive, resulting in a reinforced composite material with enhanced uniformity and optimized functional properties.

In yet another embodiment of the present invention, the plug form of waste/dust, bonding agent, thermoplastic polymer, and charcoal additive are blended in a melt compounding process using at least one of a twin-screw extruder, continuous mixer, or batch mixer. The feeding scheme is configured to enable uniform distribution of each component. The compressed plugs are introduced at a primary feed location, and the charcoal additive is introduced either simultaneously through a co-feeder or downstream into the mixing zone to promote homogeneous distribution. The controlled feeding and melting compounding process ensures optimal dispersion of all components, leading to a reinforced composite material with consistent quality, superior mechanical properties, and reliable performance.

In yet another embodiment of the present invention, the compounded composition is pelletized via an extrusion process to form pellets suitable for downstream molding, forming, or additive manufacturing. This enhances material handling, storage, and processability, enabling efficient and versatile use in various manufacturing applications.

In still another embodiment of the present invention, the compounded composition is extruded into a continuous filament or string form suitable for spooling and use in three-dimensional printing processes. Thereby expanding the material's utility for advanced manufacturing and rapid prototyping.

According to a fifth aspect of the present invention, the present invention provides a method for producing a reinforced composite material. The method comprises the steps of a) collecting airborne yarn waste and/or cotton waste dust (waste/dust); b) forming the airborne yarn waste and/or cotton waste dust into a plug form; c) feeding the plug into a compounding system; d) introducing a thermoplastic polymer, a bonding agent, and a charcoal additive into the compounding system; and e) compounding the waste/dust, thermoplastic polymer, bonding agent, and charcoal additive under heat and shear to produce a reinforced composite material. The method enables efficient recycling of textile waste into high-value composite materials, promoting sustainability and resource conservation while delivering enhanced material performance. Optionally, the plug may be shredded prior to being fed into the compounding step. The shredding may be manually (by human) or with the assistance of a machine.

In an embodiment of the present invention, the step of forming the plug includes densifying the waste/dust and compacting it using at least one of mechanical pressing, hydraulic compression, extrusion-based densification, thermal bonding, or chemical binding agents. This improves handling efficiency, reduces material loss, and ensures consistent feed quality for the subsequent compounding process.

In another embodiment of the present invention, the thermoplastic polymer comprises at least one of high-density polyethylene (HDPE), polypropylene (PP), polyethylene terephthalate (PET), low-density polyethylene (LDPE), polycarbonate (PC), acrylonitrile butadiene styrene (ABS), polylactic acid (PLA), or polyamide (PA). The use of a wide range of thermoplastic polymers allows for versatility in tailoring the composite material's properties for diverse applications.

In still another embodiment of the present invention, the charcoal additive is introduced into the compounding system by at least one of (a) pre-blending with the fiber plug, (b) independent feeding using a gravimetric or volumetric feeder, or (c) blending with the thermoplastic polymer prior to introduction. The use of multiple introduction methods for the charcoal additive ensures flexible processing and consistent dispersion within the composite.

In still another embodiment of the present invention, the compounding system comprises at least one of a twin-screw extruder, continuous mixer, or batch mixer, and the components are introduced through at least one or more feed inlets arranged to ensure even mixing. Optimized mixing equipment and feed arrangements promote uniform blending, resulting in a composite material with consistent quality and properties.

In another embodiment of the present invention, further comprising the step of pelletizing the compounded material by extruding the blended composition through a die, cooling the extrudate in a water bath, and cutting into pellets. This facilitates easy handling, storage, and downstream processing of the composite material.

In still another embodiment of the present invention, further comprising drying the pelletized material to remove residual moisture before any molding or forming operation. This prevents defects and ensures optimal quality during subsequent molding or forming processes.

In yet another embodiment of the present invention, the extrudate may be cooled and pelletized by a Under Water Pelletizer (UWP).

In yet another embodiment of the present invention, further comprising molding the dried, pelletized material into a structural article by at least one of injection molding, compression molding, or extrusion molding. This allows the pelletized material to efficiently convert into a variety of structural products using standard molding techniques.

In still another embodiment of the present invention, the compounded composition is extruded into a continuous string or filament and winding onto a spool for use in three-dimensional (3D) printing. This expands the application in advanced manufacturing.

In yet another embodiment of the present invention, the resulting composite material includes uniformly dispersed fibers and charcoal additive, and exhibits improved structural strength, dimensional stability, or thermal performance as compared to compositions without the charcoal additive. The presence of the charcoal additive significantly enhances the overall tensile strength of the composite material and mitigates foul odors.

In still another embodiment of the present invention, the charcoal additive provides at least one of antimicrobial or odor-absorbing properties to the reinforced composite material. The composite material gains added functional benefits such as improved hygiene and odor control.

In yet another embodiment of the present invention, the charcoal additive is derived from pyrolyzed agricultural waste selected from at least one of coconut shells, rice husks, bamboo, or walnut shells. Sourcing the charcoal from agricultural waste supports sustainability and adds value to discarded biomass.

In yet another embodiment of the present invention, the pyrolyzed charcoal is further activated via steam or chemical treatment to increase surface area and porosity. The activated charcoal provides enhanced adsorption capacity, improving the composite's functional properties.

In still another embodiment of the present invention, the charcoal additive has a particle size distribution between 10 microns and 150 microns to promote dispersion during melt compounding. The optimal particle size distribution ensures uniform dispersion and maximizes the reinforcing effect of the charcoal additive.

In yet another embodiment of the present invention, the charcoal additive is surface-treated with a compatibilizer or dispersing agent to enhance bonding with the thermoplastic matrix. This improves interfacial adhesion, leading to better mechanical properties of the composite.

In yet another embodiment of the present invention, the presence of the charcoal additive improves thermal conductivity or flame resistance of the final reinforced composite.

According to a sixth aspect of the present invention, the present invention provides a method of producing a charcoal-infused fiber plug for subsequent use in composite material manufacturing. The method comprises the steps of a) collecting airborne yarn waste and/or cotton waste dust (waste/dust); b) mixing the airborne yarn waste and/or cotton waste dust with a charcoal additive to form a fiber-charcoal blend; c) densifying the fiber-charcoal blend; d) compacting the densified blend into a plug-like structure; and e) supplying the plug to a downstream processing system for compounding with a thermoplastic polymer and a bonding agent. The method streamlines the integration of recycled fibers and charcoal additives, enabling efficient production of sustainable, high-performance composite materials and mitigating foul odors.

In one example, the charcoal additive is provided and fed in the form of pellets, each pellet having a controlled size and shape to facilitate uniform distribution and integration within the composite material during compounding.

Further objectives, features, and advantages of the present invention will become apparent when studying the following detailed disclosure, the drawings, and the appended claims. Those skilled in the art will realize that different features of the present invention can be combined to create embodiments other than those described in the following.

### BRIEF DESCRIPTION OF THE DRAWINGS

The drawings illustrate the design and utility of embodiments of the present invention, in which similar elements are referred to by common reference numerals. In order to better appreciate the advantages and objects of the embodiments of the present invention, reference should be made to the accompanying drawings that illustrate these embodiments. However, the drawings depict only some embodiments of the invention and should not be taken as limiting its scope. With this caveat, embodiments of the invention will be described and explained with additional specificity and detail through the use of the accompanying drawings in which:

FIG. 1 illustrates a system for forming a reinforced composite material in accordance with an embodiment of the present invention;

FIG. 2 illustrates an apparatus for manufacturing a cotton waste plug in accordance with an embodiment of the present invention;

FIG. 3 illustrates sub-modules of a system for forming a reinforced composite material in accordance with an embodiment of the present invention;

FIG. 4 illustrates an injection molding module of a system in accordance with an embodiment of the present invention;

FIG. 5 illustrates test results of the final reinforced composite after pelletizing and before injection molding in accordance with an embodiment of the present invention;

FIG. 6 illustrates test results of the final reinforced composite after pelletizing and before injection molding in accordance with an embodiment of the present invention;

FIG. 7 illustrates a method flow diagram for manufacturing a cotton waste plug in accordance with an embodiment of the present invention;

FIG. 8 illustrates a method flow diagram for forming a blended composition in accordance with an embodiment of the present invention;

FIG. 9 illustrates a method flow diagram for injection molding a blended composition to form an end product in accordance with an embodiment of the present invention;

FIG. 10 (A) illustrates a system for forming a reinforced composite material in accordance with an embodiment of the present invention;

FIG. 10 (B) illustrates a result of Young's modulus performed on the thermoplastic polymer blend containing 25% cotton in accordance with an embodiment of the present invention;

FIG. 10 (C) illustrates a result of specific gravity performed on the thermoplastic polymer blend containing 25% cotton in accordance with an embodiment of the present invention;

FIG. 11 illustrates a method for producing a reinforced composite material in accordance with an embodiment of the present invention; and

FIG. 12 illustrates a method for producing a charcoal-infused fiber plug for subsequent use in composite material manufacturing in accordance with an embodiment of the present invention.

The illustrated embodiments are merely examples and are not intended to limit the disclosure. The schematics are drawn to illustrate features and concepts and are not necessarily drawn to scale.

### DETAILED DESCRIPTION

The present disclosure is best understood with reference to the detailed figures and description set forth herein. Various embodiments have been discussed with reference to the figures. However, a person skilled in the art will readily appreciate that the detailed descriptions provided herein with respect to the figures are merely for explanatory purposes, as the methods and system may extend beyond the described embodiments. For instance, the teachings presented, and the needs of a particular application may yield multiple alternatives and suitable approaches to implement the functionality of any detail described herein. Therefore, any approach may extend beyond certain implementation choices in the following embodiments.

Methods of the present invention may be implemented by performing or completing, executing manually, automatically, or a combination thereof, selected steps or tasks. The term “method” refers to manners, means, techniques, and procedures for accomplishing a given task, including, but not limited to, those manners, means, techniques, and procedures either known to or readily developed from known manners, means, techniques, and procedures by practitioners of the art to which the invention belongs. The descriptions, examples, methods, and materials presented in the claims and the specification are not to be construed as limiting but rather as illustrative only. Those skilled in the art will envision many other possible variations within the scope of the technology described herein.

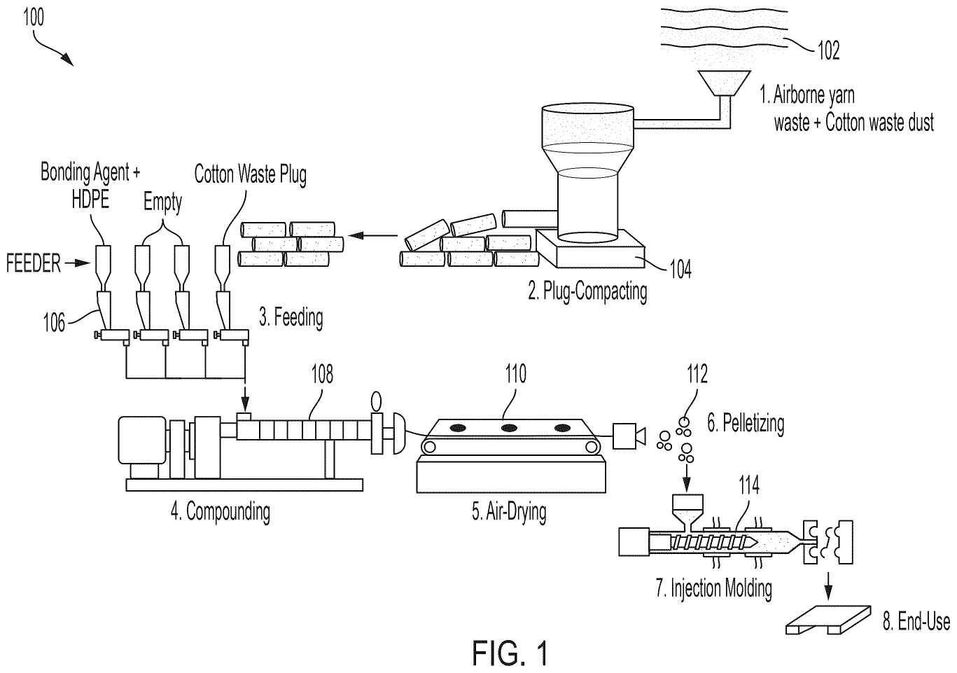

FIG. 1 illustrates a system 100 for forming a reinforced composite material in accordance with an embodiment of the present invention. The system 100 comprises a collection module 102, an apparatus 104, a feeding module 106, a compounding module 108, a drying module 110, a pelletizing module 112, and an injection molding module 114.

The collection module 102 collects an airborne yarn waste or cotton waste dust (waste/dust) from various sources, including fabrication and recycling processes. The cotton waste dust and the airborne yarn waste are pre-consumer cotton waste materials used in creating cotton waste plugs. The cotton waste dust, a fine byproduct from combing, is collected via filtration and reused in yarn production, while the airborne yarn waste, consisting of larger fiber clusters and lint from the knitting/weaving process, is captured through air filtration or cleaning. Both are vital for recycling and sustainable textile production, with distinct compositions and collection methods.

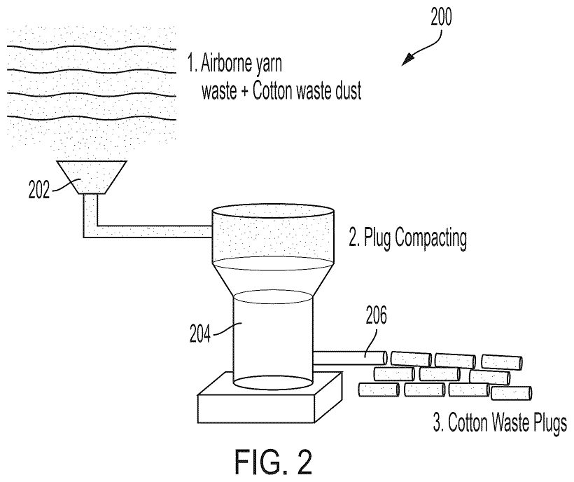

The apparatus 104 receives the airborne yarn waste or the cotton waste dust from the collection module 102. The apparatus 104 is configured to compact or compress the received airborne yarn waste or the cotton waste dust to a cotton waste plug. The functionality and structure of the apparatus 104 is discussed in detail in FIG. 2. The apparatus 104 addresses a critical need in the textile industry by providing a method to recycle waste materials.

The feeding module 106 receives the compacted or compressed cotton waste plug from the apparatus 104. The feeding module 106 may include one or more feeding units, configured to receive a thermoplastic polymer and a bonding agent.

The compounding module 108 receives the compacted or compressed cotton waste plug, the thermoplastic polymer and the bonding agent from the feeding module 106 to form a reinforced composite material or a blended composition. The compounding module 108 may include an extruder to form a strand-like structure of the blended composition which is further fed to the drying module 110.

The drying module 110 receives the strand-like structure or string of the blended composition directly from the compounding module 108 and performs a thorough drying operation. The drying module 110 ensures the removal of excess moisture from the material, which is essential for maintaining the quality, stability, and performance of the composition in subsequent manufacturing stages.

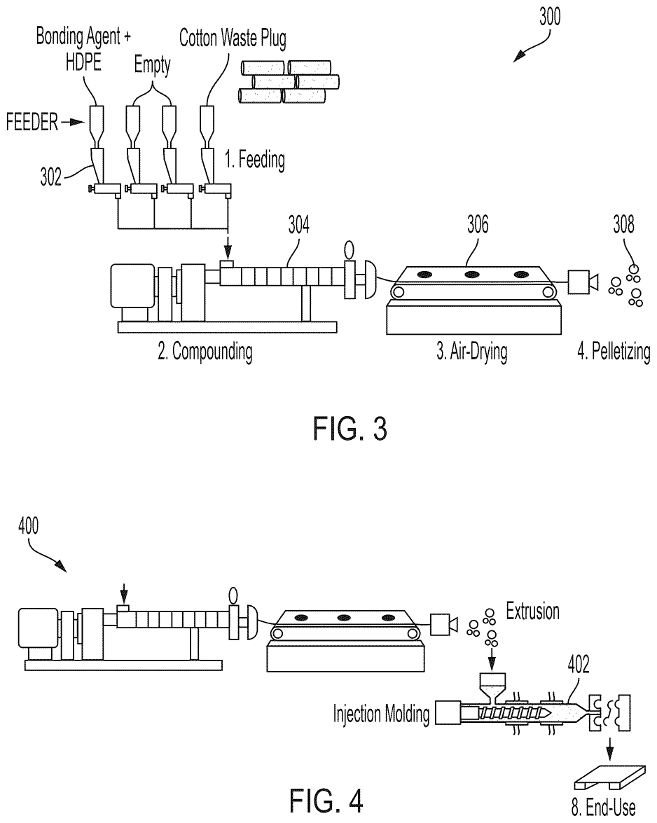

The pelletizing module 112 receives the dried strands or strings of the blended composition from the drying module 110 and cuts the dried strands or strings into pellets. The feeding module 106, the compounding module 108, the drying module 110 and the pelletizing module 112 are discussed in detail in FIG. 3.

The injection molding module 114 is injection molded into an end or a finished product. The end or finished product is a structural product used for transport and storage applications. The injection molding module 114 is discussed in detail in FIG. 4. The system 100 is designed to efficiently manufacture high-performance, durable composites suitable for various industrial applications.

FIG. 2 illustrates an apparatus 200 for manufacturing a cotton waste plug in accordance with an embodiment of the present invention. The apparatus 200 comprises an input source unit 202, a plunger unit 204, and an output unit 206.

The input source unit 202 is designed with a funnel shape, allowing it to efficiently receive airborne yarn waste or cotton waste dust from various sources, including fabrication and recycling processes or from the collection module (discussed in FIG. 1). This design ensures that the airborne yarn waste or the cotton waste dust is collected effectively, minimizing waste and maximizing the input material for processing.

The input source unit 202 may include a cabinet (not shown) to collect the airborne yarn waste or the cotton waste dust, which serves as a central processing chamber. The input source unit 202 or the cabinet is equipped with a vacuum pump that creates a negative pressure environment or suction force. This suction force is crucial for attracting and retaining the airborne yarn waste within the apparatus 200, ensuring that the material is properly contained and prepared for further processing.

The input source unit 202 may comprise a de-lumper unit (lump breaker) to break the airborne yarn waste or the cotton waste dust into smaller, uniform pieces to facilitate consistent feeding. The de-lumper unit may be connected at the input or the output end of the input source unit 202.

Once the cabinet is full, the airborne yarn waste or the cotton waste dust is directed to the plunger unit 204. The plunger unit 204 is responsible for compacting or compressing the airborne yarn waste at 100 PSI into a densified or compressed cotton waste plug. The plunger unit 204 may utilize at least one mechanical pressing, hydraulic compression, extrusion-based densification, thermal bonding, or chemical binding agents to apply the necessary pressure for compacting or compressing the airborne yarn waste or the cotton waste dust into a compressed cotton waste plug. The plunger unit 204 may be a linear plunger. Alternatively, the plunger unit 204 is a rotary plunger. The plunger unit 204 comprises at least one screw type, hydraulic type, piston type, and/or roller type. This process is essential for converting the loose airborne yarn waste into a more manageable and usable product.

The cotton waste plug comprises at least one of wool, flax, hemp, jute, polyester, nylon, or other natural or synthetic textile fibers obtained from pre-consumer apparel waste.

In one example, a humidity level of the cotton waste plug is less than 10%.

The output unit 206 is configured to output the densified cotton waste plug from the apparatus 200. The output unit 206 is equipped with a shaping die responsible for the shape of the densified cotton waste plug.

Further, the length of the shaping die decides the length of the cotton waste plug leaving the output unit 206. The length of the shaping die may cause a breaking line over the output at a certain length due to gravity applying over the output.

In one example, the shape of the densified cotton waste plug is cylindrical.

In another example, the shape of the densified cotton waste plug is square or rectangular.

The densified cotton waste plug may form into various shapes depending on the shape of the shaping die.

As the densified cotton waste plug exits the output unit 206, gravity breaks the densified cotton waste plug apart at a level where the gravity overcomes the weight to create the plug. The plug could be made shorter by increasing the height of the cabinet or lowering the exit tube.

The densified cotton waste plug offers improved transportability and storability compared to conventional fragile cotton sheets due to its enhanced density.

Alternatively, the output unit 206 may comprise a cutting unit or a mechanical cutter for breaking the output or the compacted blended composition.

The term “cotton waste plug”, “the plug” or “densified cotton waste plug” is used interchangeably throughout the specification and refer to the same entity and meaning. It conventionally refers to the processed product of airborne yarn waste but may refer to an unprocessed version of the collected airborne yarn waste.

FIG. 3 illustrates sub-modules of a system 300 for forming a reinforced composite material in accordance with an embodiment of the present invention. The system 300 includes a feeding module 302, a compounding module 304, a drying module 306, and a pelletizing module 308.

The feeding module 302 receives the compacted or compressed cotton waste plug from the apparatus (discussed in detail in FIG. 2). The feeding module 302 may include one or more feeding units, configured to receive a thermoplastic polymer, a bonding agent and the cotton waste plug. The feeding module 302 is designed to facilitate the integration of various materials necessary for creating a blended composition or the reinforced composite material.

For example, the first feeding unit 302-1 is configured to receive a thermoplastic polymer, which serves as the matrix material in the blended composition. The second feeding unit 302-2 is designated for the bonding agent, which enhances the adhesion between the polymer and the cotton waste plug. Additionally, the third feeding unit 302-3 is intended for delayed feeding and is currently shown as empty, indicating that the third feeding unit 302-3 may be used for future material inputs or adjustments in the process. The fourth feeding unit 302-4 is specifically tasked with receiving the cotton waste plug either directly or from the apparatus (discussed in FIG. 2), ensuring that this key component is efficiently integrated into the blended composition formulation. In one scenario, the fourth feeding unit 302-4 may receive the cotton waste plug from the apparatus either through a direct connection or via a conveyor belt, facilitating efficient material transfer into the composite formation process. The cotton waste plugs are introduced at a controlled rate via the fourth feeding unit 302-4. This structured approach within the feeding module 302 optimizes material handling and preparation, ultimately contributing to the production of high-quality reinforced composites.

In one example, the fourth feeding unit 302-4 may include a de-lumper unit or lump breaker to break the cotton waste plugs into small uniform pieces. The small uniform pieces of cotton waste facilitate consistent feeding.

In another example, the first and second feeding units (302-1, 302-2) may also include a de-lumper unit or lump breaker to break the thermoplastic polymer and the bonding agent into small uniform pieces.

The de-lumper is connected at an input end of the feeding units (302-1, 302-2, 302-4). In an alternate embodiment of the present invention, the de-lumper is connected at an output end of the feeding units (302-1, 302-2, 302-4).

The feeding module 302 may include a chamber module (not shown). The chamber module further comprises one or more chamber units for storing the thermoplastic polymer, the bonding agent and the cotton waste plug.

The compounding module 304 receives the compacted or compressed cotton waste plug, the thermoplastic polymer and the bonding agent from the feeding module 302 to form a reinforced composite material or a blended composition. The compounding module 304 includes a heating unit (not shown). The heating unit may comprise a feed zone, melting zone, and/or melt-pumping zone. The feed zone receives the small uniform pieces of the cotton waste plug or the airborne yarn waste, the thermoplastic polymer, and the bonding agent. The melting zone may include a heater for heating the thermoplastic polymer to a temperature sufficient to soften or melt the polymer.

The melt-pumping zone of the heating unit is utilized for pumping or forcing the cotton waste plug or the airborne yarn waste, the bonding agent and the thermoplastic polymer in a forward direction or towards the drying module 306. The heating unit facilitates the controlled blending of the melted thermoplastic polymer, the bonding agent with the cotton waste plug or the airborne yarn waste to form a blended composition or a reinforced composite material. The heating unit facilitates the uniform dispersion of the small uniform cotton waste plug or the airborne yarn waste within the thermoplastic polymer matrix. The heating unit may utilize a screw-type compactor which is of a low-shear screw design to prevent degradation or burning of the fibers during the blending process.

Alternatively, the airborne yarn waste or cotton waste plug is blended with the thermoplastic polymer and the bonding agent in a melt compounding process utilizing at least one of a twin-screw extruder, continuous mixer, or batch mixer to ensure controlled blending. In one example, the cotton waste dust is directly fed into the polymer melt, while in other cases, the cotton waste plug itself is introduced into the melt and broken down during processing.

The heating unit may comprise a heater and/or a temperature sensor. The temperature sensor monitors real-time temperature to aid the heater or the heating unit in maintaining the sufficient temperature required for the melting of the thermoplastic polymer. The heating unit may perform extrusion of the blended composition and force the blended composition towards an output unit of the compounding module 304.

The output unit outputs a strand-like structure or string of the blended composition. The compounding module 304 may include an extruder to form a strand-like structure or a string of the blended composition which is further fed to the drying module 306.

The drying module 306 receives the strand-like structure or the string of the blended composition. The strands-like structure or string of the extruded blended composition is introduced into a water bath or A.C.-enclosed conveyor belt to solidify (cool and dry without the water bath) while retaining residual heat to evaporate surface moisture. The drying module 306 ensures the removal of excess moisture from the material, which is essential for maintaining the quality, stability, and performance of the composition in subsequent manufacturing stages. The extruded blended composition is in continuous form or pelletized using a shaping die. The cooled string may be further pelletized for feeding into injection molding applications or may be spooled to form a roll for feeding into a 3-D printer for B2C applications.

The pelletizing module 308 is a vital component of the composite material production system, responsible for transforming dried strands or strings of blended composition received from the drying module 306. Once the blended composition has undergone drying to remove moisture, the composition is presented in the form of elongated strands. The pelletizing module 308 then employs an extrusion process to cut these dried strands into uniform pellets. This process not only standardizes the size and shape of the pellets but also ensures that they are suitable for subsequent processing stages, particularly injection molding, as elaborated in FIG. 4. The extrusion technique used in the pelletizing module allows for efficient handling and processing of the material, facilitating its conversion into a form that can be easily transported and utilized in manufacturing. By producing consistent pellets, pelletizing module 308 enhances the overall efficiency and quality of the composite material production process, ensuring that the final products exhibit desirable properties and performance characteristics. This step is crucial in preparing the blended composition for effective integration into various applications across multiple industries.

In one of the embodiments, the cotton waste plug or collected airborne yarn waste may be introduced through a side feeder into chamber 4 or so of the 10-chamber twin-screw heating process, allowing the thermoplastic polymer and bonding agent mixture to fully homogenize before encountering the fibers. By positioning the plug input point downstream from the thermoplastic polymer and bonding agent feeders, the system 300 ensures that the polymer blend has sufficient time to melt and mix thoroughly before interacting with the yarn or cotton waste, promoting uniform dispersion and enhancing fiber-matrix adhesion in the final reinforced composite material. Other feeding chambers are possible in order to allow the thermoplastic polymer and bonding agent mixture to fully homogenize before encountering the fibers.

FIG. 4 illustrates an injection molding module 402 of a system 400 in accordance with an embodiment of the present invention. The injection molding module 402 is designed to receive pellets produced by the pelletizing module, which is discussed in detail in FIG. 3. Once the pellets are delivered to the injection molding module 402, they undergo a transformation process where they are heated and injected into molds to create finished products or end products. The injection molding process allows for precise control over the shape and characteristics of the finished product, ensuring that it meets specific design and performance criteria. The injection molding module 402 not only enhances the efficiency of production but also enables the creation of complex geometries and structures that are essential in various applications across different industries. By effectively utilizing the pellets derived from the preceding stages of production, the injection molding module 402 plays a crucial role in turning raw materials into high-quality composite products ready for market use. The pellets may be molded into a variety of finished products, including but not limited to logistics pallets, hangers, construction materials, automotive components, and eco-friendly consumer goods.

By utilizing cotton waste in this manner, the present invention not only reduces textile waste but also enhances the mechanical properties of thermoplastic composites, contributing to more sustainable and high-performance materials for a range of industrial applications.

The compacted shape and size of the blended composition or the reinforced composite material as an output from the injection molding module 402 is due to the structure of a shaping die in the injection molding module 402. The shape of the shaping die decides the output shape of the finished product. The shape of the output may be cylindrical, rectangular, square, or other known shapes.

Further, the length of the shaping die decides the length of the finished product leaving the injection molding module 402. The length of the shaping die may cause a breaking line over the output at a certain length due to gravity applying over the output.

Alternatively, the injection molding module 402 may comprise a cutting unit or a mechanical cutter for breaking the output or the compacted blended composition.

The various materials involved in the formation of the blended composition. The composition includes (a) the airborne yarn waste, (b) the bonding agent, (c) a thermoplastic polymer, and (d) the final reinforced composite material, also referred to as the blended composition throughout this specification. The blended composition is formed by incorporating airborne yarn waste, derived from the cotton waste plug, into a thermoplastic polymer matrix, including the bonding agent, creating the final reinforced composite material with enhanced bio-mechanical properties.

The cotton waste plug serves as the primary source of airborne yarn waste, which is compounded with the thermoplastic polymer through a melting compounding process. This process ensures a uniform distribution of fibers within the polymer matrix, leading to a reinforced composite material with superior tensile strength, impact resistance, and durability. Once blended, the reinforced composite material undergoes further processing, such as injection molding, compression molding, or extrusion molding, to produce finished products.

In one exemplary embodiment, the blended composition consists of 12% the airborne yarn waste and 88% thermoplastic polymer, specifically High-Density Polyethylene (HDPE) (other chemical agents). This composition has demonstrated a 22% improvement in tensile strength compared to non-reinforced thermoplastic materials. In other embodiments, the airborne yarn waste content in the blended composition ranges from 12% to 30%, while the thermoplastic polymer content ranges from 70% to 88%, allowing for flexibility in material properties depending on the intended application.

The thermoplastic polymer used in the blended composition can include one or more of polypropylene (PP), polyethylene terephthalate (PET), low-density polyethylene (LDPE), polycarbonate (PC), acrylonitrile butadiene styrene (ABS), polylactic acid (PLA), or polyamide (PA), providing versatility in a material selection based on application-specific requirements.

The bonding agent, such as Orevac or any maleic anhydride, is mixed with high-density polyethylene (HDPE) at a typical ratio of 92% HDPE and 8% bonding agent to create a compatible polymer blend, which is then combined with cotton waste plugs or collected airborne yarn waste to produce a reinforced composite material with improved mechanical properties and fiber-matrix adhesion.

Post-consumer textile waste presents greater challenges due to the presence of dyes, finishes, and blended fibers. One potential solution involves cryogenic milling, where worn or discarded cotton garments are frozen and pulverized into a fine powder. This powder, although no longer suitable for textile applications, can be compounded with high-density polyethylene (HDPE) to create reinforced composites. This post-consumer approach not only diverts complex waste from landfills but also adds mechanical strength to the HDPE matrix, offering a second life to discarded textiles in durable, non-textile applications.

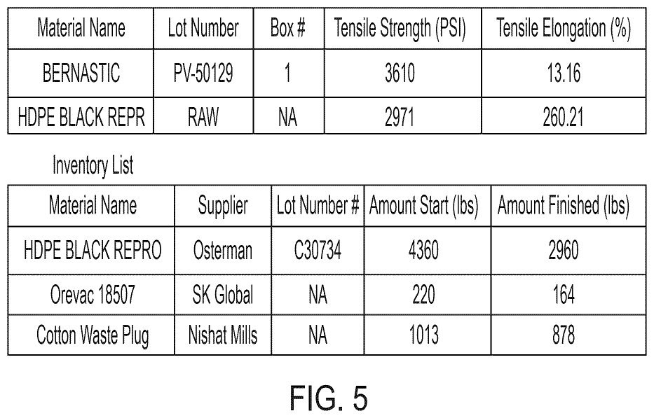

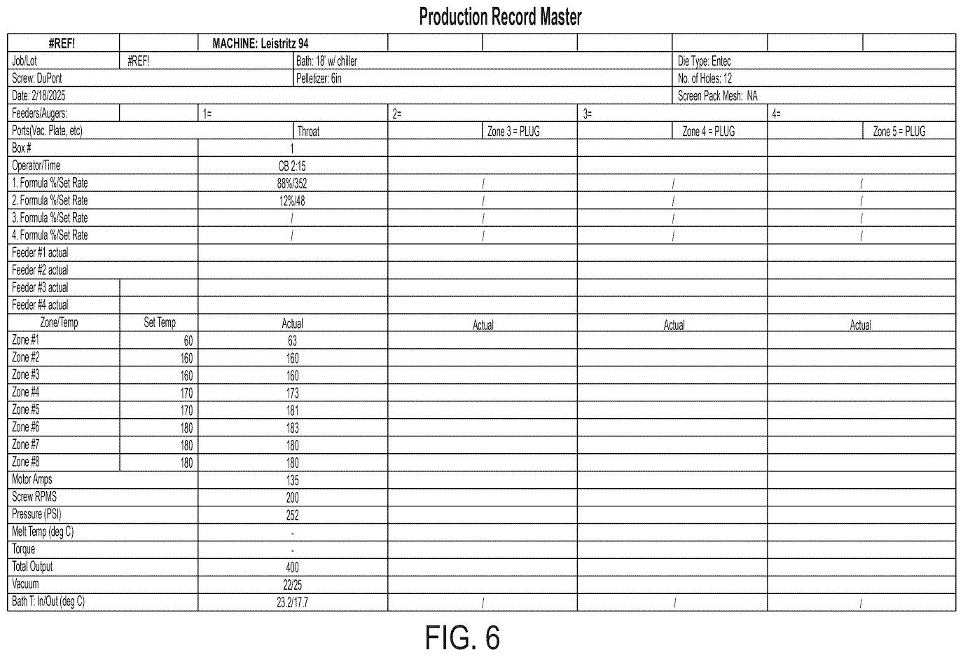

FIGS. 5 and 6 illustrate test results of the final reinforced composite after pelletizing and before injection molding in accordance with an embodiment of the present invention. In the present invention, the reinforced composite material (BERNASTIC) is manufactured by collecting airborne yarn waste and, or cotton waste dust to be compounded with a thermoplastic polymer and bonding agent. The thermoplastic polymers are High-Density Polyethylene, Black, and Reprocessed (HDPE BLACK REPRO). The bonding agent (maleic annhydride) is Orevac 18507. The amount of cotton waste plugs, HDPE BLACK REPRO, and Orevac being mixed is 1013, 4360, and 220, respectively. As a result, the tensile strength of the reinforced composite material is 3610 PSI (22% improvement) and tensile elongation improvement is 13.16%.

To further enhance the mechanical properties and functional performance of HDPE composites, reinforcement can extend beyond cotton waste powder to include rigid, mineral-based fillers such as crushed porcelain, quartz, and feldspar. These ceramic and silicate materials introduce significant hardness, abrasion resistance, and dimensional stability to the composite, complementing the fibrous reinforcement provided by the cotton waste. Crushed porcelain and quartz, with their high compressive strength and thermal resistance, improve stiffness and impact resistance, while feldspar contributes to the composite's toughness and thermal stability

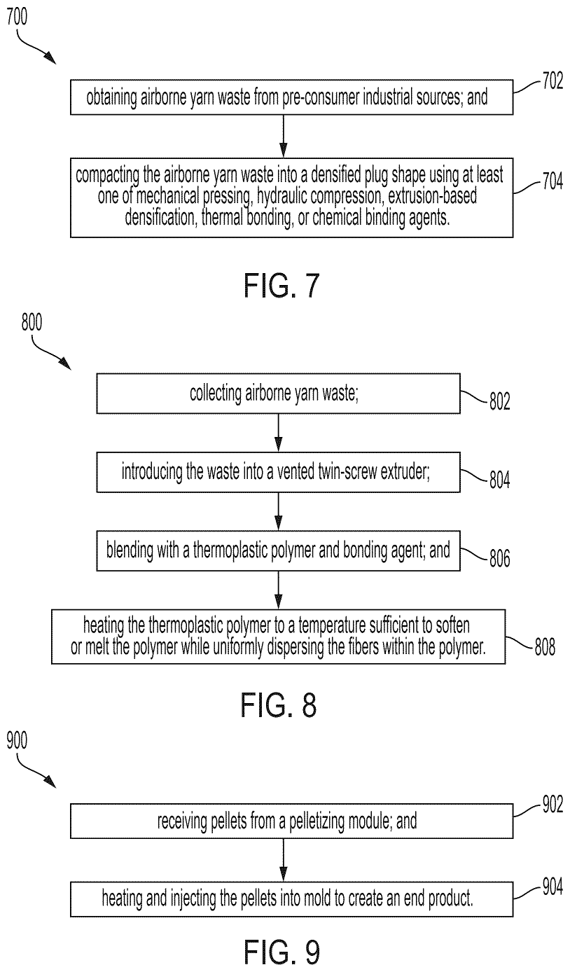

FIG. 7 illustrates a method 700 flow diagram for manufacturing a cotton waste plug in accordance with an embodiment of the present invention. The method 700 comprises the steps of a) obtaining airborne yarn waste from pre-consumer industrial sources 702; and b) compacting the airborne yarn waste into a densified plug shape using at least one of mechanical pressing, hydraulic compression, extrusion-based densification, thermal bonding, or chemical binding agents 704.

The collection of airborne yarn waste is essential for reducing environmental impact by reusing materials that would otherwise be discarded.

This compaction process results in the densified plug shape that is not only compact but also durable, making it suitable for efficient storage and transportation. The enhanced density of the plug reduces storage space requirements and facilitates handling, contributing to cost savings and environmental benefits.

FIG. 8 illustrates a method 800 flow diagram for forming a blended composition in accordance with an embodiment of the present invention. The method 800 comprises the steps of: a) collecting airborne yarn waste 802; b) introducing the waste into a vented twin-screw extruder 804; c) blending with a thermoplastic polymer and bonding agent 806; and d) heating the thermoplastic polymer to a temperature sufficient to soften or melt the polymer while uniformly dispersing the fibers within the polymer 808.

Further, extruding the blended composition into a continuous form or pelletizing the material using a strand-cut die system. In other embodiments, a spooling version of the extruded strands may be possible that will allow it to work with 3D printers. The strands emerging from the die may be introduced into a water bath to solidify while retaining residual heat to evaporate surface moisture before cutting into pellets and ensuring the pelletized material is dried before injection molding, using a customer-equipped dryer system to remove any moisture absorbed from the atmosphere during storage or transport. Further, the dried, pelletized material is injection molded into an end product, and the end product is a structural product used for transport and storage applications.

The reinforced composite material involves using a specific thermoplastic polymer, such as polypropylene or polyethylene, which is heated to a suitable temperature to ensure optimal softening and melting while uniformly dispersing the cotton waste fibers or the airborne yarn waste fibers within the polymer matrix. This enhances the mechanical properties of the composite by ensuring compatibility between the polymer and the fibers.

Further, the method focuses on improving the dispersion of cotton waste fibers or airborne yarn waste fibers within the thermoplastic polymer matrix. This is achieved by incorporating a mixing aid during the blending process. The low-shear screw design of the extruder is further optimized to minimize fiber breakage, ensuring a uniform distribution of fibers throughout the composite material.

The extrusion process is customized to produce a continuous form with specific dimensions, such as cylindrical rolls, which can be directly used in various applications without the need for pelletizing. This approach reduces processing steps and enhances the efficiency of the manufacturing process.

The method may use advanced drying techniques during the pelletizing process. Instead of a water bath, a controlled air drying system is employed to solidify the strands while minimizing moisture absorption. This ensures that the pellets have a lower moisture content, which is crucial for maintaining the quality and consistency of the composite material during injection molding.

The strands may enter a conveyor belt that is enclosed and air conditioned in order to solidify the strands while minimizing moisture absorption.

In other embodiments, the extruded strands may enter an Under Water Pelletizer for pelletizing, and optionally, further cooled/dried.

The injection molding process specializes in producing complex geometries or thin-walled parts. This is achieved by using high-pressure injection molding machines and optimizing the mold design to ensure uniform filling and cooling of the composite material. The result is a finished product with enhanced structural integrity and aesthetic appeal.

The present invention involves combining cotton waste plugs with other reinforcement materials, such as carbon fibers or glass fibers, to produce the reinforced composite material. This approach allows for tailoring the mechanical properties of the composite material to meet specific application requirements, such as improved strength, stiffness, or impact resistance. The reinforcement is achieved during the blending process, ensuring a uniform distribution of all reinforcement materials within the thermoplastic polymer matrix.

While not illustrated, in one embodiment, the blending process for incorporating the cotton waste plug into the thermoplastic polymer, such as HDPE, is designed to accommodate a higher cotton waste content, increasing from 12% to up to 30%. This process involves the low-shear screw design within the compounding extruder to minimize heat buildup and prevent thermal degradation or “burning” of the cotton fibers. Due to the low bulk density of cotton waste, a side-feeding system is utilized to ensure consistent material input. An Acrison feeder, equipped with dual agitators in the hopper, may be implemented to improve feeding efficiency and maintain a steady material flow. Additionally, the de-lumper (lump breaker) may be used to break down larger fiber clusters, promoting better dispersion during compounding.

A vented compounding extruder, such as a Farrel Continuous Mixer or a parallel twin-screw extruder (e.g., Leistritz, Coperion), may be employed to facilitate fiber dispersion while utilizing vacuum venting to remove residual moisture. The pelletizing process is performed using a strand-cut die system, which allows the extruded strands to briefly contact water or A.C.-enclosed conveyor belt before being cut into pellets, leveraging residual heat to promote surface water evaporation. To further control moisture absorption, downstream processing may include a drying system to remove any atmospheric moisture from the pellets before injection molding or extrusion.

Increasing the airborne yarn waste content in the composite material by up to 30% offers potential benefits, including reducing dependency on virgin (or recycled) HDPE, lowering production costs, and improving the sustainability of the final product. The increased fiber content may also enhance mechanical properties, such as tensile strength, impact resistance, and thermal and acoustic insulation, making the composite material suitable for a range of applications, including logistics pallets, hangers, construction materials, automotive components, and eco-friendly consumer goods.

FIG. 9 illustrates a method 900 flow diagram for injection molding a blended composition to form an end product in accordance with an embodiment of the present invention. The method comprises the steps of a) receiving pellets from a pelletizing module 902 and; b) heating and injecting the pellets into mold to create an end product 904.

In step 902, the blended composition is processed into pellet form for ease of handling and uniformity in material properties.

In step 904, the molten material is subsequently injected into a mold under controlled pressure and temperature conditions. Inside the mold, the material takes the shape of the cavity, forming the desired configuration of the end product. The molded product is then allowed to cool and solidify within the mold, ensuring dimensional stability and structural integrity. Finally, the solidified product is ejected from the mold, completing the process. This method 900 ensures efficient transformation of blended compositions into high-quality finished products with precise shapes and properties suitable for various industrial applications.

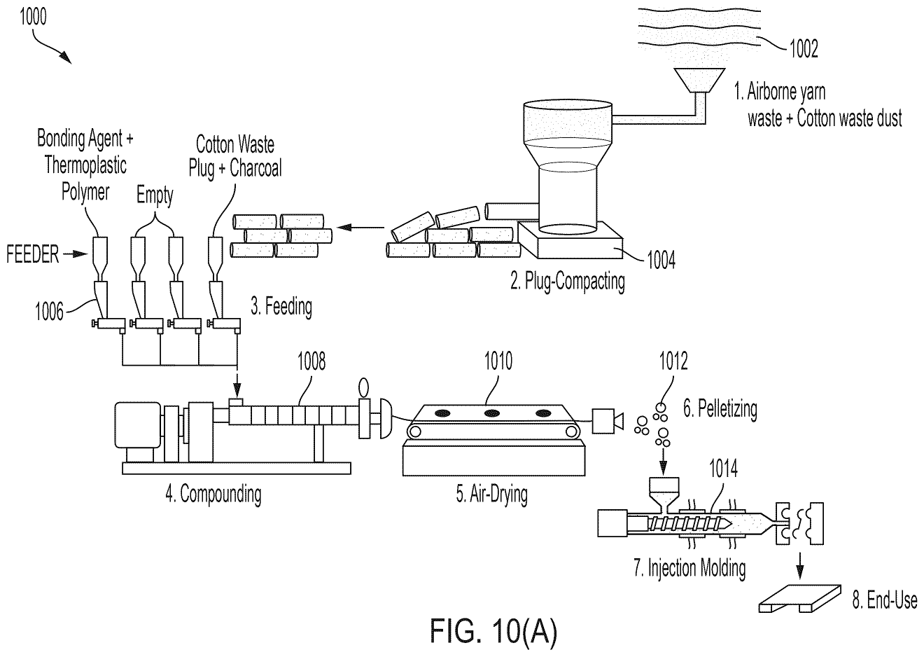

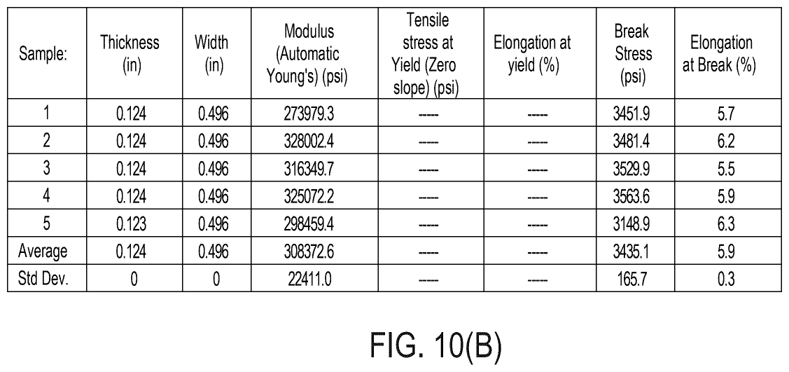

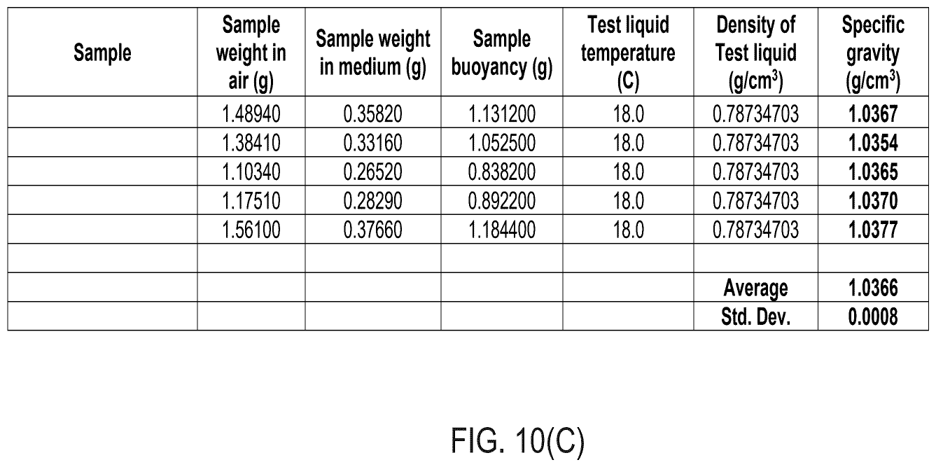

FIG. 10 (A) illustrates a system 1000 for forming a reinforced composite material in accordance with an embodiment of the present invention. The system 1000 includes a collection module 1002, an apparatus 1004, a feeding module 1006, a compounding module 1008, a drying module 1010, a pelletizing module 1012, and an injection molding module 1014.

The collection module 1002 is configured to collect airborne yarn waste and/or cotton waste dust (hereinafter referred to as waste/dust) from a variety of sources, such as fabrication and recycling processes. The collected airborne yarn waste and/or cotton waste dust is then conveyed to the apparatus 1004, which is specifically designed to densify and subsequently compact or compress the received airborne yarn waste or cotton waste dust into a cotton waste plug. The densification and compaction processes within the apparatus 1004 are already discussed in FIG. 1.

Following compaction, the cotton waste plug is transferred to the feeding module 1006. The feeding module 1006 is equipped to receive the compacted or compressed cotton waste plug from the apparatus 1004 and may comprise one or more feeding units configured to receive materials such as the airborne yarn waste or cotton waste dust in plug form, a bonding agent, a thermoplastic polymer, and a charcoal additive. These feeding units may be gravimetric or volumetric, allowing for precise and consistent delivery of each component. In one example, the charcoal additive is provided and fed in the form of pellets, each pellet having a controlled size and shape to facilitate uniform distribution and integration within the composite material during compounding.

The type of the bonding agent and the thermoplastic polymer used during the process is discussed in detail in FIG. 1 and FIG. 4.

The charcoal additive, which is a key feature of the invention, comprises at least one of an activated charcoal, biochar, or carbon black derived from biomass or recycled organic material. The charcoal additive is provided in a particulate form selected from powder, granules, or micronized particles suitable for uniform mixing during compounding. Further, the charcoal additive is present in an amount ranging from 0.5% to about 2.5% by weight of the total composition and has a particle size distribution between 10 microns and 150 microns to promote dispersion during melt compounding. The charcoal additive provides at least one of antimicrobial or odor-absorbing properties to the reinforced composite material. The charcoal additive is derived from pyrolyzed agricultural waste, including but not limited to coconut shells, rice husks, bamboo, or walnut shells. The pyrolyzed charcoal is further activated via steam or chemical treatment to increase surface area and porosity. In addition to its antimicrobial and odor-absorbing properties, the presence of the charcoal additive improves the thermal conductivity and/or flame resistance of the final reinforced composite. For improved compatibility with the thermoplastic matrix, the charcoal additive is surface-treated with a compatibilizer or dispersing agent

The feeding module 1006 may include a first feeding unit configured to receive the thermoplastic polymer and the bonding agent, a second and third feeding units are empty, and a fourth feeding unit for the airborne yarn waste or cotton waste dust in plug form along with the charcoal additive.

The compounding module 1008 receives the compacted or compressed cotton waste plug, the thermoplastic polymer, the bonding agent and the charcoal additive from the feeding module 1006 to form a reinforced composite material or a blended composition. The compounding module 1008 comprises at least one of a twin-screw extruder, continuous mixer, or batch mixer, and the components are introduced through at least one or more feed inlets arranged to ensure even mixing.

The compounding module 1008 is discussed in detail in FIG. 3 description, therefore, to avoid repetition, it is not described here. The functionality of the compounding module 1008, remain the same as described in FIG. 3.

The drying module 1010 receives the strand-like structure or string of the blended composition directly from the compounding module 1008 and performs a thorough drying operation. In one example, the compounded composition is extruded into a continuous filament or string form suitable for spooling and use in three-dimensional printing processes.

The pelletizing module 1012 receives the dried strands or strings of the blended composition from the drying module 1010 and cuts the dried strands or strings into pellets. The pellets are suitable for downstream molding, forming, or additive manufacturing. The compounded material is pelletized by extruding the blended composition through a die, cooling the extrudate in a water bath, and cutting it into pellets. The pelletized material is then dried to remove residual moisture before any molding or forming operation. The dried pelletized material is subsequently molded into a structural article by at least one of injection molding, compression molding, or extrusion molding.

In some embodiments, the cooling module and pelletizing module may be integrated into a single functional unit using an underwater pelletizer system (UWP). In this configuration, the blended composition is extruded directly through a die into a water chamber, where it is immediately cut into pellets by rotating knives positioned adjacent to the die face. The water serves the dual function of both solidifying and cooling the extrudate while simultaneously conveying the freshly cut pellets away from the cutting zone. This integration streamlines the process by eliminating the need for a separate strand-drying step prior to pelletization, as the underwater pelletizer allows for in-line cooling and size reduction in one continuous operation. The resulting pellets are then separated from the process water and dried using a centrifugal dryer or other drying mechanism, preparing them for downstream molding or additive manufacturing applications. This combined module reduces equipment footprint, simplifies material handling, and enhances overall process efficiency.

The injection molding module 1014 molds the dried pellets into an end or finished product. The resulting composite material includes uniformly dispersed fibers and charcoal additive, and exhibits improved structural strength, dimensional stability, thermal performance or conductivity, and/or flame resistance as compared to compositions without the charcoal additive.

Alternatively, the first feeding unit is used to receive the thermoplastic polymer, the second feeding unit receives the bonding agent, the third feeding unit receives the charcoal additive, and the fourth feeding unit receives the cotton waste plug.

Alternatively, the first feeding unit receives the bonding agent and thermoplastic polymer, the second feeding unit receives the charcoal additive, and the fourth feeding unit receives the cotton waste plug, with the third feeding unit remaining empty.

Alternatively, the first feeding unit receives the bonding agent and the thermoplastic polymer, and the fourth feeding unit receives the cotton waste plug pre-mixed with charcoal additive, with the second and the third feeding units remaining empty.

Alternatively, the first feeding unit receives the bonding agent and the thermoplastic polymer, the fourth feeding unit receives the cotton waste plug, with the second and third feeding units remaining empty. The charcoal additive is fed through a dedicated feeder, a fifth feeding unit, which is attached to the melt zone of the compounding module. Alternatively, the compressed plugs are introduced at a primary feed location, and the charcoal additive is introduced either simultaneously through a co-feeder or downstream into the mixing zone to promote homogeneous distribution.

Alternatively, the first feeding unit receives a pre-blended charcoal additive with the thermoplastic polymer, the second feeding unit receives the bonding agent, and the fourth feeding unit receives the cotton waste plug, with the third feeding unit remaining empty.

The functionality and structure of alternating embodiments as discussed above is the same as what is explained in FIG. 10 (A), therefore not repeated here to avoid repetition. The only difference between the FIG. 10 (A) and FIG. 1 is the addition of charcoal additive to mitigate foul odors and enhance the tensile strength of the blended composition and using different feeders (as clearly explained above) to receive cotton waste plug, charcoal additive, bonding agent and thermoplastic polymer, respectively.

FIGS. 10(B) and 10(C) illustrate the results of mechanical and physical property testing performed on the thermoplastic polymer blend containing 25% cotton. The Young's modulus of the end-product were evaluated and are summarized in FIG. 10 (B). This table includes measurements of thickness, width, modulus (Automatic Young's Modulus), break stress, and elongation at break for five tested samples, along with calculated average and standard deviation values. The results indicate consistent mechanical properties across the samples, with an average Young's modulus of 308,372.6 psi and an average break stress of 3,435.1 psi. Elongation at break was observed to be approximately 5.9% on average, demonstrating moderate ductility for the material. FIG. 10 (C) details the specific gravity and density determinations for the same blend, showing highly repeatable results with an average specific gravity of 1.0366 (g/cm³) and a standard deviation of only 0.0008. These findings highlight the end-product's uniformity and suitability for further mechanical and physical evaluation.

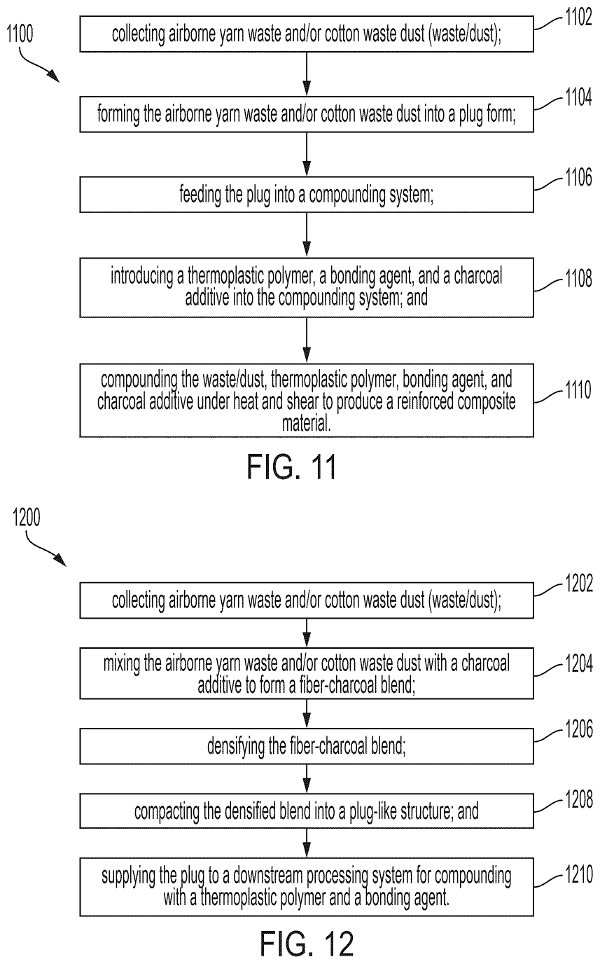

FIG. 11 illustrates a method 1100 for producing a reinforced composite material in accordance with an embodiment of the present invention. The method 1100 comprises a series of sequential steps designed to efficiently convert airborne yarn waste and/or cotton waste dust into a high-performance composite product. The method 1100 begins with the step of collecting 1102 airborne yarn waste and/or cotton waste dust (hereinafter referred to as waste/dust) from fabrication or recycling sources. This initial collection step 1102 ensures that even fine, airborne fibrous residues are effectively gathered for efficient transportation and subsequent processing, thereby promoting sustainability and reducing environmental waste.

Following collection, the method 1100 proceeds to the step of forming 1104 the airborne yarn waste and/or cotton waste dust into a plug form. The forming step 1104 specifically includes densifying the collected waste/dust and compacting it into a plug using at least one of mechanical pressing, hydraulic compression, extrusion-based densification, thermal bonding, or chemical binding agents. This compaction process transforms the loose, low-density fibers into a manageable and uniform plug, facilitating accurate dosing and efficient feeding in downstream operations.

The next step involves feeding 1106 the plug into a compounding system. Alternatively, the plug may be shredded (manually or automatically) prior to feeding into the compounding system. The compounding system may comprise at least one of a twin-screw extruder, a continuous mixer, or a batch mixer, with the plug introduced through one or more feed inlets arranged to ensure even mixing of all components. In parallel, the method 1100 includes introducing 1108 a thermoplastic polymer, a bonding agent, and a charcoal additive into the compounding system. The thermoplastic polymer may comprise at least one of high-density polyethylene (HDPE), polypropylene (PP), polyethylene terephthalate (PET), low-density polyethylene (LDPE), polycarbonate (PC), acrylonitrile butadiene styrene (ABS), polylactic acid (PLA), or polyamide (PA). The charcoal additive may be introduced into the compounding system by at least one of the following approaches: (a) pre-blending with the fiber plug, (b) independent feeding using a gravimetric or volumetric feeder, or (c) blending with the thermoplastic polymer prior to introduction. This flexibility in the introduction of the charcoal additive allows for optimal dispersion and compatibility within the composite matrix.

In an exemplary embodiment, the charcoal additive is provided and fed in the form of pellets, each having a controlled size and shape to facilitate uniform distribution and integration within the composite material during compounding. The pelletized form enables precise metering and consistent feed rates into the compounding equipment, ensuring that the additive disperses evenly throughout the polymer or matrix material. The uniformity in pellet dimensions prevents clumping or uneven mixing, which could otherwise lead to performance inconsistencies or defects in the final composite product. Furthermore, the controlled shape and size of the pellets enhance process efficiency by improving flow characteristics, reducing dust generation, and simplifying material handling and storage. This embodiment supports reproducible processing conditions and contributes to improved mechanical, thermal, and aesthetic properties in the end-use composite material, reflecting a reliable and scalable approach to incorporating the charcoal additive.

The method 1100 then advances to the compounding step 1110, wherein the airborne yarn waste and/or cotton waste dust, thermoplastic polymer, bonding agent, and charcoal additive are compounded under heat and shear to produce a reinforced composite material. The compounding system ensures thorough mixing and melting of the thermoplastic polymer, bonding agent, and uniformly disperses the fibers and charcoal additive throughout the matrix. The compounded material may then be pelletized by extruding the blended composition through a die, cooling the extrudate in a water bath, and cutting it into pellets. The pelletized material is further dried to remove residual moisture, ensuring optimal properties for subsequent molding or forming operations. The dried, pelletized material is then molded into a structural article by at least one of injection molding, compression molding, or extrusion molding.

Alternatively, the extrudate may be subject to an Under Water Pelletizer (UWP) for at least one of cooling, drying, or pelletizing.

Alternatively, the compounded composition may be extruded into a continuous string or filament and wound onto a spool for use in three-dimensional (3D) printing applications. This approach provides additional versatility, enabling the production of composite filaments suitable for additive manufacturing technologies.

The resulting composite material produced by method 1100 includes uniformly dispersed fibers and charcoal additive, and exhibits improved structural strength, dimensional stability, or thermal performance as compared to compositions without the charcoal additive. The charcoal additive, as incorporated in the method 1100, provides at least one of antimicrobial or odor-absorbing properties to the reinforced composite material. The charcoal additive is derived from pyrolyzed agricultural waste selected from at least one of coconut shells, rice husks, bamboo, or walnut shells. The pyrolyzed charcoal is further activated via steam or chemical treatment to increase its surface area and porosity, thereby enhancing its functional properties within the composite.

To promote optimal dispersion during melt compounding, the charcoal additive has a particle size distribution between 10 microns and 150 microns. Furthermore, the charcoal additive is surface-treated with a compatibilizer or dispersing agent to enhance bonding with the thermoplastic matrix. The presence of the charcoal additive in the composite material not only imparts antimicrobial and odor-absorbing properties but also improves the thermal conductivity or flame resistance of the final reinforced composite, thereby expanding its range of potential applications.

FIG. 12 illustrates a method 1200 for producing a charcoal-infused fiber plug for subsequent use in composite material manufacturing, in accordance with an embodiment of the present invention. The method 1200 is designed to efficiently integrate a charcoal additive into fibrous waste material, thereby creating a value-added intermediate suitable for downstream compounding with thermoplastic polymers and bonding agents.

The method 1200 begins with the step of collecting 1202 airborne yarn waste and/or cotton waste dust (hereinafter referred to as waste/dust) from sources such as textile fabrication, processing, or recycling operations. This initial collection step 1202 ensures the capture and recovery of fine, otherwise discarded fibrous residues, thus promoting sustainability and reducing environmental impact.

Following collection, the method advances to the step of mixing 1204 the airborne yarn waste and/or cotton waste dust with a charcoal additive to form a fiber-charcoal blend. The charcoal additive may comprise at least one of activated charcoal, biochar, or carbon black derived from pyrolyzed agricultural waste such as coconut shells, rice husks, bamboo, or walnut shells. The charcoal additive is preferably introduced in a finely divided form, such as powder, granules, or micronized particles, with a particle size distribution between 10 microns and 150 microns to ensure uniform blending with the fibrous material. The mixing step 1204 may be accomplished using mechanical mixers, blenders, or other suitable agitation equipment to achieve a homogeneous fiber-charcoal blend. The charcoal additive may be surface-treated with a compatibilizer or dispersing agent to enhance its compatibility with the fiber matrix and, ultimately, with the thermoplastic polymer in downstream processing.

Once a uniform fiber-charcoal blend has been achieved, the method proceeds to densifying 1206 the blend. The densification step 1206 may utilize at least one of mechanical pressing, hydraulic compression, extrusion-based densification, thermal bonding, or chemical binding agents to increase the bulk density of the fiber-charcoal blend. This step is critical for improving the handling characteristics of the blend, reducing its volume, and preparing it for efficient compaction.

Subsequently, the method includes compacting 1208 the densified fiber-charcoal blend into a plug-like structure. This compaction step 1208 transforms the densified blend into a uniform, manageable plug that can be easily handled, stored, and accurately dosed in subsequent processing steps. The plug-like structure ensures consistent material input for downstream compounding and enhances process control.

Finally, the method 1200 comprises supplying 1210 the charcoal-infused fiber plug to a downstream processing system. In this step, the plug is delivered to a compounding system where it will be further processed with a thermoplastic polymer and a bonding agent to produce a reinforced composite material. The integration of the charcoal additive at the plug formation stage ensures its uniform dispersion in the final composite, thereby imparting desirable properties such as antimicrobial activity, odor absorption, improved thermal conductivity, and enhanced flame resistance to the end product.

In alternative embodiments, the supplying 1210 of the charcoal-infused fiber plug is by shredding (manually or automatically) the plug form into shreds for feeding into the compounding system.

By following the steps of collecting 1202, mixing 1204, densifying 1206, compacting 1208, and supplying 1210 (or shredding), the method 1200 provides an efficient and scalable approach for producing a charcoal-infused fiber plug, optimizing both material utilization and the performance of subsequent composite materials.

Since various possible embodiments might be made of the above invention, and since various changes might be made in the embodiments above set forth, it is to be understood that all matter herein described or shown in the accompanying drawings is to be interpreted as illustrative and not to be considered in a limiting sense. Thus, it will be understood by those skilled in the art that although the preferred and alternate embodiments have been shown and described in accordance with the Patent Statutes, the invention is not limited thereto or thereby.

The terminology used herein is for the purpose of describing particular embodiments only and is not intended to be limiting to the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The present invention and some of its advantages have been described in detail for some embodiments. It should also be understood that various changes, substitutions, and alterations can be made herein without departing from the spirit and scope of the invention as defined by the appended claims. An embodiment of the invention may achieve multiple objectives, but not every embodiment falling within the scope of the attached claims will achieve every objective.

1. A reinforced composite material, comprising:
airborne yarn waste and/or cotton waste dust (waste/dust) in a plug form;
a bonding agent;
a thermoplastic polymer; and
a charcoal additive, wherein the airborne yarn waste and/or cotton waste dust is compounded with the thermoplastic polymer, bonding agent, and charcoal additive to form a reinforced composite material.

2. The composition of claim 1, wherein the charcoal additive comprises at least one of an activated charcoal, biochar, or carbon black derived from biomass or recycled organic material.

3. The composition of claim 1, wherein the charcoal additive is provided in a particulate form selected from powder, granules, or micronized particles suitable for uniform mixing during compounding.

4. The composition of claim 1, wherein the charcoal additive is present in an amount ranging from 0.5% to about 2.5% by weight of the total composition.

5. The composition of claim 1, wherein the charcoal additive is introduced during compounding by at least one of pre-mixing with the fiber plug, blending with the thermoplastic polymer or bonding agent, or via a dedicated feeder into the compounding system.

6. The composition of claim 1, wherein the charcoal additive is introduced during the compounding process by at least one of: premixing with the fiber plug prior to feeding, co-feeding into the melt zone through a dedicated feeder, or pre-blending with the polymer resin prior to compounding.

7. The composition of claim 1, wherein the plug form of waste/dust, bonding agent, thermoplastic polymer, and charcoal additive are blended in a melt compounding process using at least one of a twin-screw extruder, continuous mixer, or batch mixer, and wherein the feeding scheme is configured to enable uniform distribution of each component.

8. The composition of claim 7, wherein the plugs are introduced at a primary feed location, and the charcoal additive is introduced either simultaneously through a co-feeder or downstream into the mixing zone to promote homogeneous distribution.

9. The composition of claim 1, wherein the compounded composition is pelletized via an extrusion process to form pellets suitable for downstream molding, forming, or additive manufacturing.

10. The composition of claim 1, wherein the compounded composition is extruded into a continuous filament or string form suitable for spooling and use in three-dimensional printing processes.

11. A method for producing a reinforced composite material, comprising:
collecting airborne yarn waste and/or cotton waste dust (waste/dust);
feeding the waste/dust into a compounding system;
introducing a thermoplastic polymer, a bonding agent, and a charcoal additive into the compounding system; and
compounding the waste/dust, thermoplastic polymer, bonding agent, and charcoal additive to produce a reinforced composite material.

12. The method of claim 11, wherein the collecting of airborne yarn waste and/or cotton waste dust (waste/dust) further comprises forming a plug by densifying the waste/dust and compacting it using at least one of mechanical pressing, hydraulic compression, extrusion-based densification, thermal bonding, or chemical binding agents.

13. The method of claim 11, wherein the thermoplastic polymer comprises at least one of high-density polyethylene (HDPE), polypropylene (PP), polyethylene terephthalate (PET), low-density polyethylene (LDPE), polycarbonate (PC), acrylonitrile butadiene styrene (ABS), polylactic acid (PLA), or polyamide (PA).

14. The method of claim 11, wherein the charcoal additive is introduced into the compounding system by at least one of: (a) pre-blending with the fiber plug, (b) independent feeding using a gravimetric or volumetric feeder, or (c) blending with the thermoplastic polymer prior to introduction.

15. The method of claim 11, wherein the compounding system comprises at least one of a twin-screw extruder, continuous mixer, or batch mixer, and the components are introduced through at least one or more feed inlets arranged to ensure even mixing.

16. The method of claim 11, further comprising the step of pelletizing the compounded material by extruding the blended composition through a die, cooling the extrudate in a water bath, and cutting into pellets.

17. The method of claim 16, further comprising drying the pelletized material to remove residual moisture before any molding or forming operation.

18. The method of claim 17, further comprising molding the dried, pelletized material into a structural article by at least one of injection molding, compression molding, or extrusion molding.

19. The method of claim 11, wherein the extrudate is at least one of cooled, pelletized, or dried using an Under Water Pellitizer (UWP).

20. The method of claim 11, further comprising extruding the compounded composition into a continuous string or filament and winding onto a spool for use in three-dimensional (3D) printing.

21. The method of claim 11, wherein the resulting composite material includes uniformly dispersed fibers and charcoal additive, and exhibits improved structural strength, dimensional stability, or thermal performance as compared to compositions without the charcoal additive.

22. The method of claim 1, wherein the charcoal additive provides at least one of antimicrobial or odor-absorbing properties to the reinforced composite material.

23. The method of claim 1, wherein the charcoal additive is derived from pyrolyzed agricultural waste selected from at least one of coconut shells, rice husks, bamboo, or walnut shells.

24. The method of claim 23, wherein the pyrolyzed charcoal is further activated via steam or chemical treatment to increase surface area and porosity.

25. The method of claim 1, wherein the charcoal additive has a particle size distribution between 10 microns and 150 microns to promote dispersion during melt compounding.

26. The method of claim 1, wherein the charcoal additive is surface-treated with a compatibilizer or dispersing agent to enhance bonding with the thermoplastic matrix.

27. The method of claim 1, wherein the presence of the charcoal additive improves thermal conductivity or flame resistance of the final reinforced composite.

28. A method of producing a charcoal-infused fiber plug for subsequent use in composite material manufacturing, the method comprising:
collecting airborne yarn waste and/or cotton waste dust (waste/dust);
mixing the airborne yarn waste and/or cotton waste dust with a charcoal additive to form a fiber-charcoal blend;
densifying the fiber-charcoal blend;
compacting the densified blend into a plug-like structure; and
supplying the plug to a downstream processing system for compounding with a thermoplastic polymer and a bonding agent.

29. The method of claim 28, wherein the charcoal additive is provided and fed in the form of pellets.
